(19) United States
(12) Patent Application Publication
(10) Pub. No.: US 2010/0278425 A1
(43) Pub. Date: Nov. 4, 2010

(54) IMAGE PROCESSING APPARATUS, IMAGE PROCESSING METHOD, AND COMPUTER PROGRAM PRODUCT

(75) Inventors: Satoko TAKEMOTO, Wako-shi (JP); Hideo Yokota, Wako-shi (JP)

Correspondence Address: BRUNDIDGE & STANGER, P.C., 2318 MILL ROAD, SUITE 1020, ALEXANDRIA, VA, 22314, US

(73) Assignee: RIKEN

(21) Appl. No.: 12/609,468

(22) Filed: Oct. 30, 2009

(30) Foreign Application Priority Data
Apr. 30, 2009 (JP) 2009-110683

(51) Int. Cl. G06K 9/34

(52) U.S. Cl. 382/173

(57) ABSTRACT

An image processing apparatus, method and computer program that controls so that an image of image data is displayed on a display unit, controls so that a region of interest is indicated on the displayed image to acquire image data of the region of interest, generates an extraction region extracted from the image data by using each of the image segmentation algorithms to acquire the image data of the extraction region, calculates similarity by comparing the image data of the extraction region with the image data of the region of interest to select the image segmentation algorithm having highest similarity, and outputs image data extracted using the selected image segmentation algorithm to the display unit.

This application is based upon and claims the benefit of priority from Japanese Patent Application No. 2009-110683, filed Apr. 30, 2009, the entire contents of which are incorporated herein by reference.

### BACKGROUND OF THE INVENTION

1. Field of the Invention

The present invention relates to an image processing apparatus, an image processing method, and a computer program product.

2. Description of the Related Art

In the past, an image segmentation method of performing processing of segmenting an image based on several components and discriminating a component of the object from other components has been developed. Research on image segmentation has been actively conducted since 1970s, and a large number of image segmentation algorithms have been published until now. Image segmentation is a first step for analyzing an image or acquiring quantity data from an image and thus has been one of the important areas of research in computer vision fields over the past several decades.

In recent years, the importance of image segmentation has been increased even in medical or biological science fields. For example, in cell biology, performance improvement of a microscope makes it easy to acquire an image with high resolution for a long time, and research for quantifying a microstructure or a time change behavior of a cell based on image information and obtaining new knowledge have been actively conducted. As pre-processing of such quantification, image segmentation for a large quantity of images is a very important technique.

JP-A-2003-162718 discloses an image processing method in which a computer can automatically perform image segmentation, which is much closer to perception of a human being, for various images or segmentation tasks. The method segments a region into clusters and automatically extracts an object by using the fact that a group of pixels that configure a color area that a human perceives as a uniform on an image plane forms a dense cluster in a uniform color space.

JP-A-2006-285385 discloses an image processing method that can construct a processing algorithm according to a segmentation task to obtain the processing algorithm having high versatility. The method attempts to obtain versatility for all segmentation tasks by automatically constructing and optimizing a processing program having a tree structure form that can extract a specific object from an image by using a program based on a Genetic Algorithm. A segmentation function by the processing program of the tree structure form optimized by the Genetic Algorithm is effective only for a still image, that is, a spatial image, and thus the method adopts an optical flow to make it to correspond to a moving image, that is, a tempora—spatial image. With respect to calculation of the optical flow to perform processing of transforming an input image to a state seen from above in a pseudo manner, an imaging apparatus is constructed so that a range of an input image is defined as an output of the imaging apparatus.

Further, “Performance Modeling and Algorithm Characterization for Robust Image Segmentation” International Journal of Computer Vision, Vol. 80, No. 1, pp. 92-103, 2008, by “S. K. Shah”, discloses, as a resolution for obtaining the versatility, a method of selecting a segmentation algorithm by evaluating similarity between an extraction object set by an end user and an automatic extraction result by a computer.

However, the conventional image segmentation methods had a problem in that an image segmentation algorithm lacks the versatility. That is, since a segmentation algorithm reviewed for a certain segmentation task was not widely effective for various images or segmentation tasks, researchers were always in need of changing or newly reviewing an algorithm according to a purpose. Further, since a task related to changing or reviewing is very inefficient, there was a problem of a bottleneck of knowledge acquisition.

In particular, for example, in the method of JP-A-2003-162718, it was actually difficult for an extraction region to always form a cluster and find a feature space that can be clearly discriminated from a cluster represented by a image feature of a non-extraction region, and an effort was required in finding an ideal feature space according to an object, whereby there was a big problem in obtaining versatility.

Further, in the method of JP-A-2006-285385, a unique imaging apparatus is used so that the optical flow is adopted. However, there was a problem in that it is difficult to apply the unique imaging apparatus to obtaining a tempora-spatial observation image, for example, in medical or biological fields and to obtaining a segmentation algorithm with the versatility that handles with various tempora-spatial images.

Further, in the method by “S. K. Shah”, definition of a criterion for measuring similarity is problematic. That is, as a criterion for measuring similarity, a method of comparing brightness, texture, contrast, or shape of an image is frequently used, but a selected algorithm or segmentation accuracy varies greatly according to these criterion when used. For this reason, recently, it is regarded that it is necessary to evaluate a criterion itself, and thus an aspect appears that it is impossible to remedy the situation. Therefore, it is conceivable to have a big problem in obtaining the versatility of a criterion for measuring similarity.

### SUMMARY OF THE INVENTION

The present invention has been made to resolve the above problems, and it is an objective of the present invention to provide an image processing apparatus, an image processing method, and a computer program product in which image segmentation can be performed with high versatility for various objects.

To solve the above problems and to achieve the above objectives, an image processing apparatus according to one aspect of the present invention, includes a storage unit, a control unit, a display unit, and an input unit, wherein the storage unit stores a plurality of image segmentation algorithms and image data, and the control unit includes a first image outputting unit that controls so that an image of the image data is displayed on the display unit, a region acquiring unit that controls so that a region of interest is indicated through the input unit on the image displayed on the display unit to acquire the image data of the region of interest, an image segmenting unit that generates an extraction region extracted from the image data by using each of the image segmentation algorithms stored in the storage unit to acquire the image data of the extraction region, an image segmentation algorithm selecting unit that calculates similarity by comparing the image data of the extraction region with the image data of the region of interest to select the image segmentation algorithm that has the highest similarity, and a second image outputting unit that outputs the image data of a region extracted by using the selected image segmentation algorithm to the display unit.

According to another aspect of the present invention, in the image processing apparatus, the input unit is a pointing device, and the region acquiring unit permits a user to trace a contour of a region that the user indicates on the image through the pointing device to acquire the region of interest.

According to still another aspect of the present invention, in the image processing apparatus, the image segmentation algorithm selecting unit calculates the similarity between feature quantities of shape and texture quantified from the image data of the extraction region and those from the image data of the region of interest.

According to still another aspect of the present invention, in the image processing apparatus, the image segmentation algorithm selecting unit represents the feature quantity by a vector.

According to still another aspect of the present invention, in the image processing apparatus, the image segmentation algorithm selecting unit represents each component of the vector by a complex number or a real number.

According to still another aspect of the present invention, in the image processing apparatus, the image segmentation algorithm selecting unit represents the feature quantity of the shape by a multi-dimensional vector.

According to still another aspect of the present invention, in the image processing apparatus, the image segmentation algorithm selecting unit represents the feature quantity of the texture by a multi-dimensional vector.

The present invention relates to an image processing method, and the image processing method according to still another aspect of the present invention is executed by an information processing apparatus including a storage unit, a control unit, a display unit, and an input unit, wherein the storage unit stores a plurality of image segmentation algorithms and image data, and the method includes (i) a first image outputting process of controlling so that an image of the image data is displayed on the display unit, (ii) a region acquiring process of controlling so that a region of interest is indicated through the input unit on the image displayed on the display unit to acquire the image data of the region of interest, (iii) an image segmenting process of generating an extraction region extracted from the image data by using each of the image segmentation algorithms stored in the storage unit to acquire the image data of the extraction region, (iv) an image segmentation algorithm selecting process of calculating similarity by comparing the image data of the extraction region with the image data of the region of interest to select the image segmentation algorithm that has the highest similarity, and (v) a second image outputting process of outputting the image data of a region extracted by using the selected image segmentation algorithm to the display unit, and wherein the processes (i) to (v) are executed by the control unit.

According to still another aspect of the present invention, in the image processing method, the input unit is a pointing device, and at the region acquiring process, the control unit permits a user to trace a contour of a region that the user indicates on the image through the pointing device to acquire the region of interest.

According to still another aspect of the present invention, in the image processing method, at the image segmentation algorithm selecting process, the similarity is calculated between feature quantities of shape and texture quantified from the image data of the extraction region and those from the image data of the region of interest.

The present invention relates to a computer program product, and the computer program product according to still another aspect of the present invention has a computer readable medium including programmed instructions for a computer including a storage unit, a control unit, a display unit, and an input unit, wherein the storage unit stores a plurality of image segmentation algorithms and image data, and the instructions, when executed by the computer, cause the computer to perform (i) a first image outputting process of controlling so that an image of the image data is displayed on the display unit, (ii) a region acquiring process of controlling so that a region of interest is indicated through the input unit on the image displayed on the display unit to acquire the image data of the region of interest, (iii) an image segmenting process of generating an extraction region extracted from the image data by using each of the image segmentation algorithms stored in the storage unit to acquire the image data of the extraction region, (iv) an image segmentation algorithm selecting process of calculating similarity by comparing the image data of the extraction region with the image data of the region of interest to select the image segmentation algorithm that has the highest similarity, and (v) a second image outputting process of outputting the image data of a region extracted by using the selected image segmentation algorithm to the display unit, and wherein the processes (i) to (v) are executed by the control unit.

According to still another aspect of the present invention, in the computer program product, the input unit is a pointing device, and at the region acquiring process, the control unit permits a user to trace a contour of a region that the user indicates on the image through the pointing device to acquire the region of interest.

According to still another aspect of the present invention, in the computer program product, at the image segmentation algorithm selecting process, the similarity is calculated between feature quantities of shape and texture quantified from the image data of the extraction region and those from the image data of the region of interest.

According to the inventions, it is possible to perform image segmentation with high versatility for various objects.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a flowchart for explaining a basic principle of the present invention;

FIG. 2 is a view schematically for explaining a basic principle of the present invention;

FIG. 3 is a principle configuration view for explaining a basic principle of the present invention;

FIG. 4 is a block diagram showing an example of a configuration of the image processing apparatus to which an embodiment of the present invention is applied;

FIG. 5 is a flowchart showing an example of the overall processing of the image processing apparatus according to an embodiment of the present invention;

FIG. 6 is a view for explaining an image (a right view) in which an original image (a left view) and a indicated region of interest (ROI) are superimposed;

FIG. 7 is a view for explaining an example of a Graphical User Interface (GUI) screen implemented by controlling the input/output control interface through the control unit 102;

FIG. 8 is a flowchart for explaining an example of image segmentation processing according to an embodiment of the present invention;

FIG. 9 is a flowchart for explaining an example of score table creating processing according to an embodiment of the present invention;

FIG. 10 is a view for explaining a segmentation result of a cell region according to an embodiment of the present invention; and

FIG. 11 is a view for explaining an observation image (an original image) of a yeast Golgi apparatus and an image segmentation result according to an embodiment of the present invention.

### DETAILED DESCRIPTION OF THE PREFERRED EMBODIMENTS

Hereinafter, an embodiment of an image processing apparatus, an image processing method, and a computer program product according to the present invention will be explained in detail with reference to the accompanying drawings. The present invention is not limited to the embodiment. The present invention provides various embodiments as described below. However it should be noted that the present invention is not limited to the embodiments described herein, but could extend to other embodiments as would be known or as would become known to those skilled in the art.

In particular, an embodiment explained below will be explained focusing on an example applied to a biological science field, but the invention is not limited thereto and may be equally applied to all technical fields of image processing such as biometric authentication or facial recognition.

### Overview of Present Embodiment

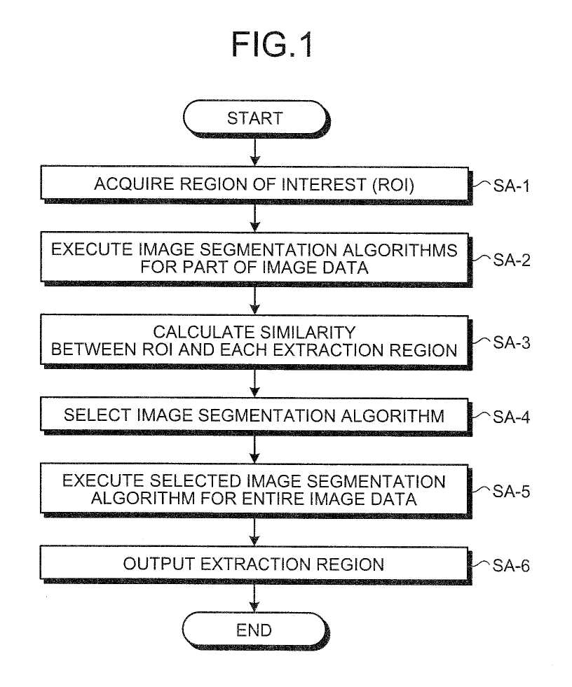

Hereinafter, an overview of an embodiment of the present invention will be explained with reference to FIGS. 1 to 3, and then a configuration and processing of the embodiment will be explained in detail. FIG. 1 is a flowchart for explaining a basic principle of an embodiment of the present invention.

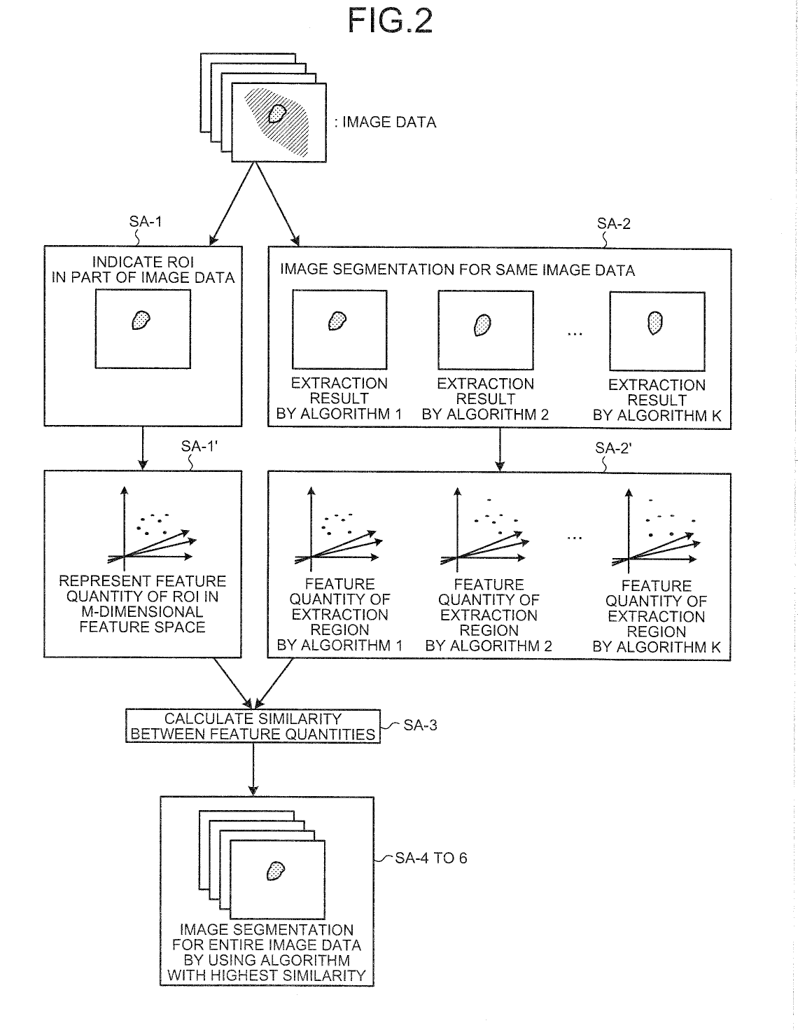

The embodiment schematically has the following basic characteristics. As shown in FIG. 1, an image processing apparatus of the embodiment controls so that an image of the image data is displayed on a display unit, and controls so that a region of interest (ROI) is indicated through the input unit on the displayed image to acquire the image data of the ROI (step SA-1). In detail, the image processing apparatus of the embodiment of the present invention may permit a user to trace a contour of a region that the user desires on the image through the pointing device to acquire the ROI. An image displayed to indicate a region of interest (ROI) is a part of one or more images included in image data. The “region of interest (ROI)” is a specific region that exemplarily represents an object to be extracted and a region that can be set according to a purpose of image segmentation. FIG. 2 is a view schematically for explaining a basic principle of an embodiment of the present invention. As shown in FIG. 2, the image processing apparatus according to the embodiment of the present invention, for example, displays part of image data and allows a user to indicate the ROI on the displayed image (step SA-1).

As shown in FIG. 1, the image processing apparatus generates an extraction region extracted from the part of the image data by using each of the image segmentation algorithms to acquire the image data of the extraction region (step SA-2). An “extraction region” is a region that is automatically extracted by execution of an image segmentation algorithm and a variable region that is generated according to a type of an image segmentation algorithm. As shown in FIG. 2, the image processing apparatus executes, for example, image segmentation algorithms 1 to K for the same image data as the image used to indicate the ROI to generate different extraction regions and acquire image data of the extraction regions (step SA-2).

The image processing apparatus may numerically convert image data of the acquired extraction region and image data of the ROI into feature quantities having concepts (elements) of shape and texture as explained in steps SA-1′ and SA-2′ of FIG. 2. The “texture” is a quantity that is acquired from a certain region in which an image is present and based on a change of an intensity value. For example, the texture is obtained by calculating a local statistics (a mean value or a variance) of a region, applying an auto-regressive model, or calculating a frequency of a local region by the Fourier transform.

The image processing apparatus calculates similarity between the image data by comparing the image data of the extraction region with that of the ROI (step SA-3). In further detail, as explained in SA-3 of FIG. 2, the image processing apparatus may calculate similarity between feature quantities into which the image data of the extraction region and the image data of the ROI are numerically converted.

The image processing apparatus selects the image segmentation algorithm that has the highest of the calculated similarities (step SA-4).

As shown in FIG. 1, the image processing apparatus executes the selected image segmentation algorithm for entire image data (step SA-5) and outputs image data of the extraction region for entire image data on the display unit (step SA-6).

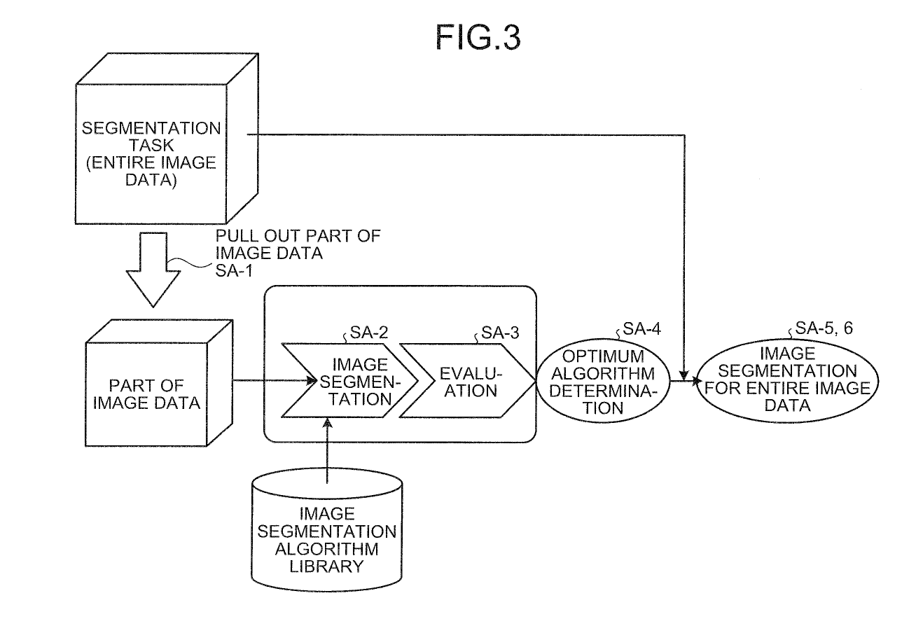

The overview of a flowchart according to an embodiment of the present invention has been explained hereinbefore. FIG. 3 is a principle configuration view for explaining a basic principle of an embodiment of the present invention.

As shown in FIG. 3, according to the embodiment of the present invention, a ROI is controlled to be indicated from an image displayed on a display unit through an input unit to acquire the image data of the ROI (step SA-1). Image segmentation is performed by using each of image segmentation algorithms stored in an image segmentation algorithm library of a storage unit, and image data of the extraction region is acquired (step SA-2). Similarity between the image data of the ROI and that of each extraction region is evaluated (step SA-3), and the image segmentation algorithm (that is, an optimum algorithm) with highest similarity is determined (step SA-4). Image data of the extraction region extracted by applying the selected image segmentation algorithm from the entire image data is output on the display unit (step SA-5, 6).

As explained above, according to the present embodiment, the image segmentation algorithm effective for solving segmentation tasks can be selected based on a user's knowledge and experience for a segmentation task of a certain object. Therefore, time and effort in which the user has to review the image segmentation algorithm several times are reduced, and image segmentation with high versatility to different image features or various objects can be automatically executed, whereby it is possible to smoothly obtain knowledge.

### Configuration of Image Processing Apparatus

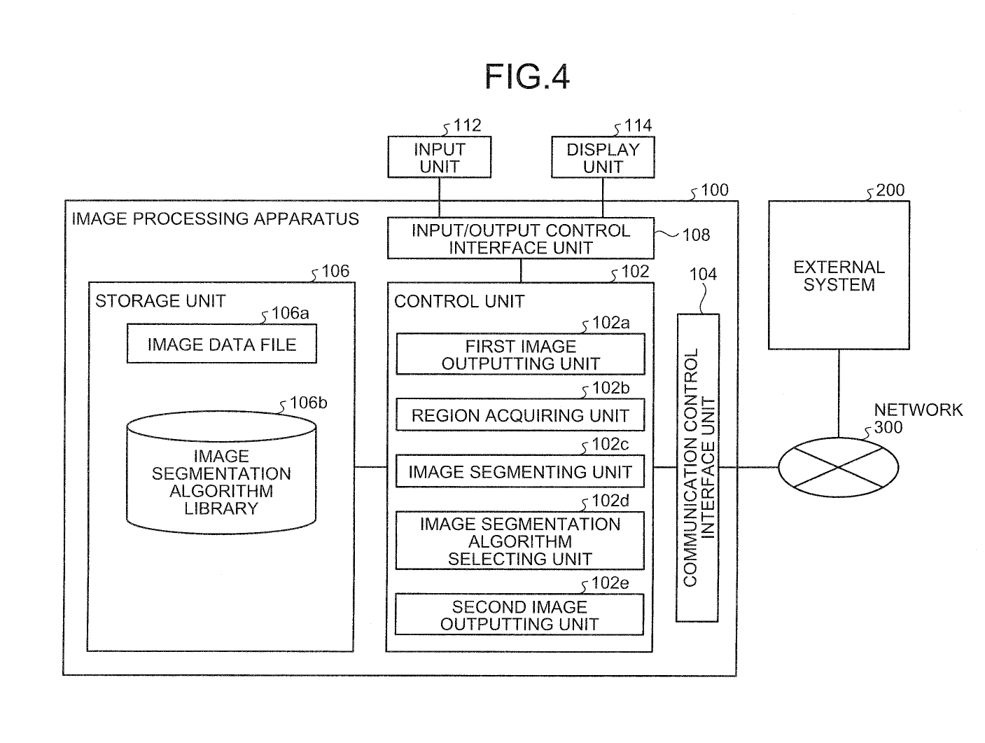

Next, a configuration of an image processing apparatus will be explained below with reference to FIG. 4. FIG. 4 is a block diagram showing an example of a configuration of an image processing apparatus 100 to which the present embodiment is applied. FIG. 4 schematically depicts a configuration of a part related to an embodiment of the present invention.

As shown in FIG, 4, the image processing apparatus 100 schematically includes a control unit 102, an input/output control interface unit 108 connected to an input unit 112 and a display unit 114, and a storage unit 106. The control unit 102 is a CPU and the like that integrally controls the entire operation of the image processing apparatus 100. The input/output control interface unit 108 is an interface connected to the input unit 112 and the display unit 114. The storage unit 106 is a device that stores various databases or tables. These components are communicably connected through an arbitrary communication path.

The various databases or tables (an image data file 106a and an image segmentation algorithm library 106b) stored in the storage unit 106 are storage means such as a fixed disk device. For example, the storage unit 106 stores various programs, tables, files, databases, web pages, and the like which are used in various processes.

Of these constituent elements of the storage unit 106, the image data file 106a stores image data and the like. Image data stored in the image data file 106a is data including one or more images that are configured by, for example, a four-dimensional space of x-y-z-t (x axis-y axis-z axis-time axis) at a maximum. For example, the image data is data including one or more images of an x-y slice image (two dimensions), an x-y slice image×z (three dimensions), an x-y slice image×time phase t (three dimensions), an x-y slice image×z×time phase t (four dimensions) or the like. Image data of the ROI or the extraction region is, for example, data in which the ROI or the extraction region is set for part of an image configured in at a maximum four-dimensional space according to the same dimension configuration as a tempora-spatial image of image data included in the image data file 106a. Image data of the indicated ROI or the extraction region is stored as a mask. The mask is segmented in units of pixels similarly to an image, and each pixel has label information together with coordinate information. For example, label 1 is set to each pixel in the ROI indicated by the user, and label 0 is set to each pixel in the other region. The mask is used for evaluation of the extraction region generated by using the image segmentation algorithm and thus sometimes called a “teacher mask”.

The image segmentation algorithm library 106b stores a plurality of image segmentation algorithms. The image segmentation algorithm is configured by, for example, an algorithm for executing a feature extraction method of measuring a feature quantity from an image and a classification method of clustering the feature quantities (classifying the features) to discriminate a region. That is, in the embodiment of the present invention, the image segmentation algorithm for executing segmentation processing in correspondence to pattern recognition is used as an example. Pattern recognition is processing of determining which class of observed patterns an obtained feature belongs to and processing of making the observed pattern correspond to one of the previously determined concepts. In this processing, a numerical value (a feature quantity) that can represent the observed pattern well is first measured based on the feature extraction method. Processing of making the feature quantity correspond to one of the concepts is performed based on the classification method. That is, a pattern space of image data is transformed into an m-dimensional feature space X=(x₁, x₂, . . . xₘ)^{T} by the feature extraction method, and the m-dimensional feature space is transformed into a conceptual space C₁, C₂, . . . , C_{K} in correspondence to a concept (a teacher mask) defined by the user by the classification method. Therefore, when the image segmentation algorithm is executed, an object class is determined by pattern recognition. There is a high possibility that image segmentation based on pattern recognition will have higher accuracy than an algorithm configured by a combination of image filters.

The image segmentation algorithm library 106b stores a plurality of feature extraction methods and a plurality of classification methods as an example of the image segmentation algorithms, and their parameters. For example, when the image segmentation algorithm library 106b stores M types of feature extraction methods, N types of classification methods, and P types of parameters, the image segmentation algorithm library 106b stores, by combinations thereof, M×N×P types of feature extraction algorithms. Each of combinations among the feature extraction methods, the classification methods, and the parameters are evaluated relative to each other based on a score of similarity calculated by an image segmentation algorithm selecting unit 102d.

The feature extraction method of the image segmentation algorithm stored in the image segmentation algorithm library 106b, a feature quantity such as brightness, color value, texture statistical quantity, higher-order local autocorrelation feature, differential feature, co-occurrence matrix, two-dimensional Fourier feature, frequency feature, scale invariant feature transform (SIFT) feature, and directional element feature, or multi-scale feature thereof is measured. The classification method of the image segmentation algorithm stored in the image segmentation algorithm library 106b includes discriminating a region based on a k-nearest neighbor (KNN), an approximate nearest neighbor (ANN), a support vector machine (SVM), a linear discrimination analysis, a neural network, a genetic algorithm, a multinomial logic model or the like. In addition, all techniques regarding classification method called supervised learning may be applied as the classification method. Further, the teacher mask may be used as a dummy, and an unsupervised clustering method (for example, a k-mean clustering technique) may be used. The parameters of the image segmentation algorithm stored in the image segmentation algorithm library 106b are parameters related to a kernel function, parameters related to the number of referenced neighboring pixels, or the like.

In FIG. 4, the input/output control interface unit 108 controls the input unit 112 and the display unit 114. As the display unit 114, not only a monitor (including a household-use television) but also a speaker may be used. As the input unit 112, not only a pointing device such as a mouse device and stylus, but also a keyboard, an imaging device or the like may be used.

In FIG. 4, the control unit 102 has an internal memory to store a control program such as an OS (Operating System), a program that defines various procedures, and required data. The control unit 102 performs information processing to execute various processes by these programs or the like. The control unit 102 functionally conceptually includes a first image outputting unit 102a, a region acquiring unit 102b, an image segmenting unit 102c, an image segmentation algorithm selecting unit 102d, and a second image outputting unit 102e.

The first image outputting unit 102a controls so that an image of the image data stored in the image data file 106a is displayed on the display unit 114.

The region acquiring unit 102b controls so that a region of interest (ROI) is indicated through the input unit 112 on the image displayed on the display unit 114 to acquire the image data of the ROI. For example, the region acquiring unit 102b has a user to trace a contour of a region that the user indicates on the image displayed on the display unit 114 through the pointing device, which is the input unit 112, to acquire the ROI. The region acquiring unit 102b may control the input unit 112 and the display unit 114 through the input/output control interface unit 108 to implement a graphical user interface (GUI), and perform control so that the user can input image data or various setting data as well as the ROI through the input unit 112. The input data may be stored in the storage unit 106.

The image segmenting unit 102c generates an extraction region extracted from image data by using the image segmentation algorithm stored in the image segmentation algorithm library 106b. For example, the image segmenting unit 102c generates an extraction region extracted from the same image data as the image in which the ROI is indicated by the region acquiring unit 102b, by using each of the image segmentation algorithms stored in the image segmentation algorithm library 106b to acquire the image data of the extraction region. The image segmenting unit 102c generates an extraction region from the entire image data stored in the image data file 106a by using the image segmentation algorithm selected by the image segmentation algorithm selecting unit 102d to acquire image data of the extraction region. The image segmenting unit 102c may perform each job by parallel processing by a cluster machine to inhibit a computation cost of each processing of the image segmentation algorithms from being increased.

The image segmentation algorithm selecting unit 102d calculates similarity by comparing the image data of the extraction region generated by the image segmenting unit 102c with the image data of the ROI acquired by the region acquiring unit 102b to select the image segmentation algorithm that has the highest similarity. The image segmentation algorithm selecting unit 102d may calculate the similarity between feature quantities of shape and texture quantified from the image data of the extraction region and those from the image data of the ROT. The image segmentation algorithm selecting unit 102d may calculate a score of similarity, and create and store a score table in the storage unit 106. The score table stores, for example, information such as a feature quantity (a vector), a type and a parameter of the image segmentation algorithm, and similarity.

As an example, measurement of similarity by the image segmentation algorithm selecting unit 102d is realized by evaluating “closeness” between the ROI and the extraction region. As a determination criterion of “closeness”, various factors may be considered, however, a feature derived from a pixel value such as brightness or texture and contour shape of a region can be regarded as one of the factors that the user most pays attentions to among the various factors. Therefore, “closeness” is evaluated by comparing feature quantities of shape and texture quantified from these regions.

The feature quantity used for similarity calculation processing by the image segmentation algorithm selecting unit 102d may be one which is represented by a vector or one in which each element of the vector is represented by a complex number or a real number. Each concept of the shape or texture of the feature quantity may be represented by a multidimensional vector.

The second image outputting unit 102e outputs the image data of a extraction region extracted by the image segmenting unit 102c from the entire image data by using the selected image segmentation algorithm selected by the image segmentation algorithm selecting unit 102d to the display unit 114. The second image outputting unit 102e may perform control so that an image of the image data of the extraction region can be displayed on the display unit 114. The second image outputting unit 102e may calculate a statistical quantity of the extraction region and control the display unit 114 so that statistical data can be displayed. For example, the second image outputting unit 102e may calculate a statistical quantity (brightness, an average, a maximum, a minimum, a variance, a standard deviation, a covariance, a PCA, and a histogram) of the extraction region of image data.

The overview of the configuration of the image processing apparatus 100 has been explained hereinbefore. The image processing apparatus 100 may be communicably connected to a network 300 through a communication device such as a router or a wired or wireless communication line such as a leased line. The image processing apparatus 100 may be connected to an external system 200 which provides an external program such as an image segmentation algorithm and an external database related to parameters through the network 300. In the FIG.4, a communication control interface unit 104 of the image processing apparatus 100 is an interface connected to a communication device (not shown) such as a router connected to a communication line or the like, and performs communication control between the image processing apparatus 100 and the network 300 (or a communication device such as a router). Namely, the communication control interface unit 104 has a function of performing data communication with another terminal through a communication line. The network 300 has a function of connecting the image processing apparatus 100, and the external system 200 with each other. For example, the Internet is used as the network 300. The external system 200 is mutually connected to the image processing apparatus 100 through the network 300 and has a function of providing an external database related to parameters or an external program such as an image segmentation algorithm and evaluation method program to a user. The external system 200 may be designed to serve as a WEB server or an ASP server. The hardware configuration of the external system 200 may be constituted by an information processing device such as a commercially available workstation or personal computer and a peripheral device thereof. The functions of the external system 200 are realized by a CPU, a disk device, a memory device, an input unit, an output unit, a communication control device, and the like in the hardware configuration of the external system 200 and programs which control these devices.

### Processing of Image Processing Apparatus 100

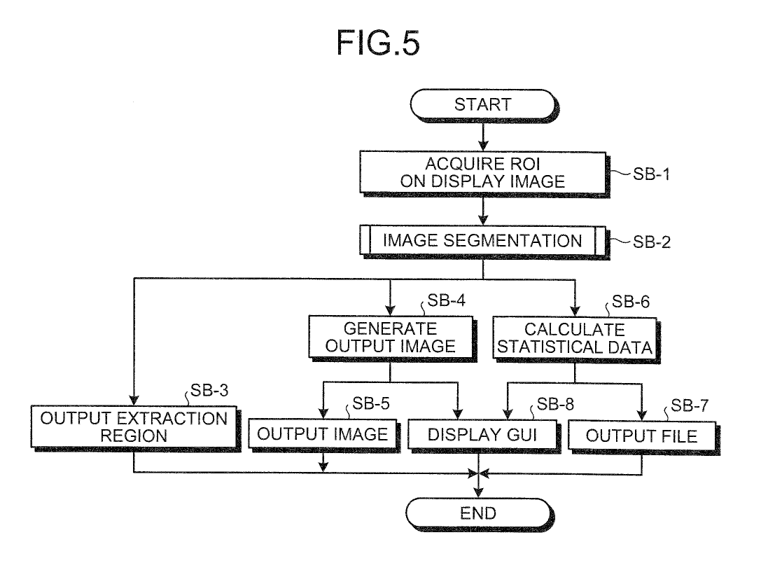

Next, an example of processing of the image processing apparatus 100 according to the present embodiment constructed as described above will be explained below in detail with reference to FIGS. 5 to 11.

Overall Processing

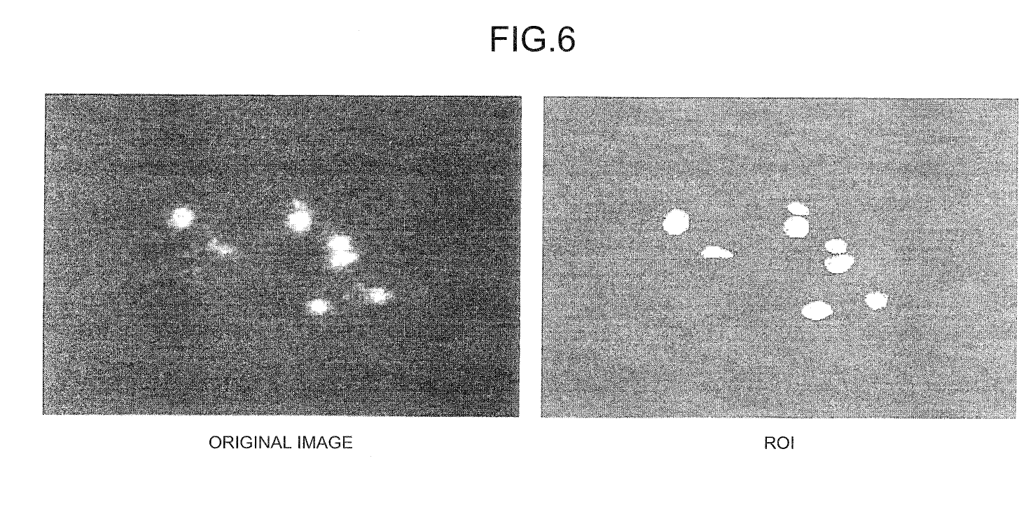

First of all, a detail of overall processing according to the image processing apparatus 100 will be explained below with reference to FIGS. 5 and 6. FIG. 5 is a flowchart showing an example of the overall processing of the image processing apparatus 100 according to an embodiment of the present invention.

As shown in FIG. 5, the first image outputting unit 102a controls so that an image of the image data stored in the image data file 106a is displayed on the display unit 114, and the region acquiring unit 102b controls so that a ROI is indicated through the input unit 112 on the displayed image to acquire the image data of the ROI (step SB-1). More preferably, the region acquiring unit 102b controls the input/output control interface unit 108 to provide the user with a graphic user interface (GUI) and the user is permitted to trace a contour of a region, which is to be indicated, on the image displayed on the display unit 114 through a pointing device as the input unit 112 to acquire the ROI. FIG. 6 is a view for explaining an image (a right view) in which an original image (a left view) and an indicated ROI of image data are superimposed.

As shown in FIG. 6, the user traces a contour of a region, which is to be indicated, on a displayed original image through the pointing device to indicate the ROI. Image data of the indicated ROI is stored as a mask. The mask is segmented in units of pixels similarly to an image, and each pixel has label information together with coordinate information. For example, label 1 is set to each pixel the ROI indicated by the user, and label 0 is set to each pixel in the other region.

The image segmenting unit 102c generates an extraction region from the image data by using each of the image segmentation algorithms stored in the image segmentation algorithm library 106b to acquire image data of the extraction region for each image segmentation algorithm (step SB-2). The image segmentation algorithm selecting unit 102d calculates similarity by comparing the image data of the extraction region with that of the ROI to select the image segmentation algorithm in which the similarity between these image data is highest, generates an extraction region from the entire image data, and outputs the generated extraction region to a predetermined region of the storage unit 106 (step SB-3).

The second image outputting unit 102e integrates the extraction region and an image of image data, generates an output image which is the image extracted from the image data corresponding to the extraction region (step SB-4), and outputs the output image to a predetermined region of the storage unit 106 (step SB-5). For example, the second image outputting unit 102e performs a Boolean operation of original image data and the extraction region (the mask) to create image data in which a brightness value 0 is set to a region where label 0 is set (other than the extraction region where label 1 is set).

The second image outputting unit 102e calculates a statistical quantity according to a predetermined total data calculation method based on the extraction region and the image of the image data to create statistical data (step SB-6), and outputs the statistical data to a predetermined region of the storage unit 106 (step SB-7).

The second image outputting unit 102e controls the input/output control interface unit 108 to provide the user with the implemented GUI and controls the input/output control interface unit 108 so that the generated output image and the calculated statistical data can be displayed (for example, three-dimensionally displayed) on the display unit 114 (step SB-8).

As a result, the overall processing of the image processing apparatus 100 is finished.

Setting Processing

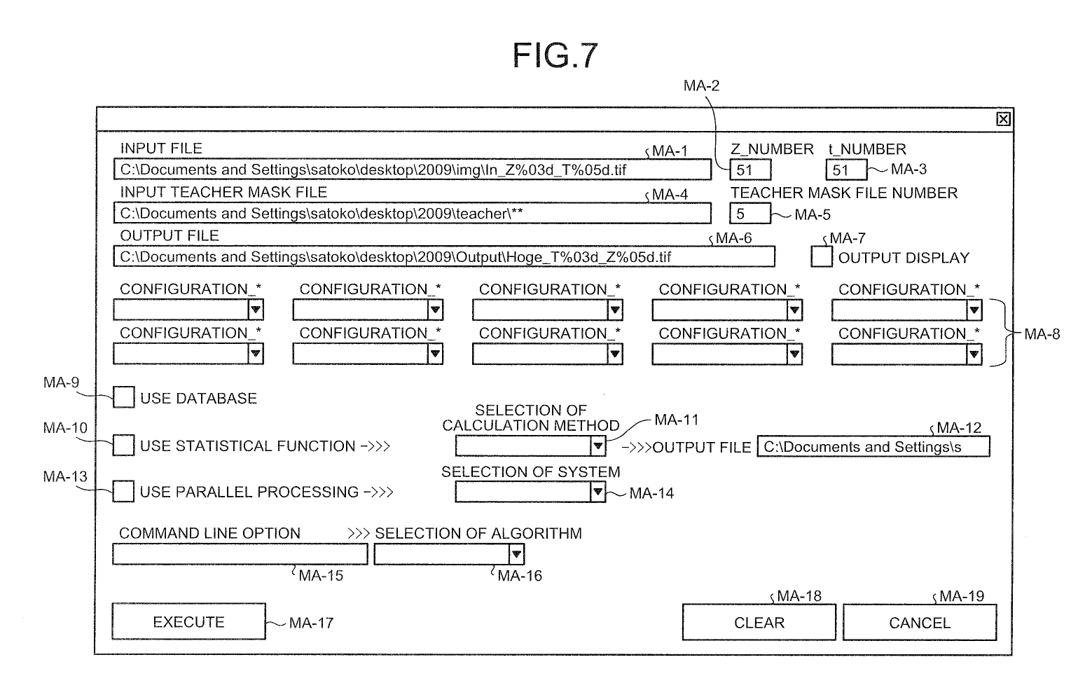

Next, setting processing of various setting data as pre-processing for executing the overall processing explained above will be explained with reference to FIG. 7. FIG. 7 is a view for explaining an example of a GUI screen implemented by controlling the input/output control interface through the control unit 102.

As shown in FIG. 7, an input file setting box MA-1, a Z number (Z_num) input box MA-2, a t number (t_num) input box MA-3, an input teacher mask file setting box MA-4, a teacher mask file number input box MA-5, an output file setting box MA-6, an output display setting check box MA-7, configuration selecting tabs MA-8, a database use setting check box MA-9, a statistical function use setting check box MA-10, a calculation method selecting tab MA-11, an output file input box MA-12, a parallel processing use check box MA-13, a system selecting tab MA-14, a command line option input box MA-15, an algorithm selecting tab MA-16, an execution button MA-17, a clear button MA-18, and a cancel button MA-19 are displayed on the GUI screen as an example.

As shown in FIG. 7, the input file setting box MA-1 is a box in which a file including image data is designated. The Z number (Z_num) input box MA-2 and the t number (t_num) input box MA-3 are boxes in which the number of the Z-axis direction and the number of the time phase of an image(s) of image data are input. The input teacher mask file setting box MA-4 is a box in which a file including the ROI (the teacher mask) is designated. The teacher mask file number input box MA-5 is a box in which the data number of image data indicating the ROI is input. The output file setting box MA-6 is a box in which an output destination of the extraction region, the output image, or the score table is set. The output display setting check box MA-7 is a check box in which operation information for designating whether to display image data (an output image) of the extraction region on the display unit 114 is set. The configuration selecting tabs MA-8 are selecting tabs in which operation information for designating various operations of the control unit 102 is set. The database use setting check box MA-9 is a check box in which it is set whether to store a history of the score table calculated by the image segmentation algorithm selecting unit 102d in a database and execute selection of the image segmentation algorithm by using the database.

Further, as shown in FIG. 7, the statistical function use setting check box MA-10 is a check box in which it is set whether to output statistical data calculated by the second image outputting unit 102e by using the numerical function. The calculation method selecting tab MA-11 is a selecting tab in which the statistical data calculation method for calculating the statistical data through the second image outputting unit 102e is selected. The output file input box MA-12 is a box in which an output destination of the statistical data calculated by the second image outputting unit 102e is input. The parallel processing use check box MA-13 is a check box in which it is set whether to perform parallel processing at the time of execution of the image segmentation algorithms through the image segmenting unit 102c. The system selecting tab MA-14 is a selecting tab in which a system such as a cluster machine used when performing parallel processing through the image segmenting unit 102c is designated. The command line option input box MA-15 is a box in which a command line option is designated in a program that makes function as the image processing apparatus 100. The algorithm selecting tab MA-16 is a selecting tab in which a type (a type of the feature extraction method or the classification method or a range of a parameter) of the image segmentation algorithm used for image segmentation through the image segmenting unit 102c is designated. The execution button MA-17 is a button that starts execution of processing by using the setting data. The clear button MA-18 is a button that releases the setting data. The cancel button MA-19 is a button that cancels execution of processing.

As explained above, the control unit 102 controls the input/output control interface unit 108 to display the GUI screen on the display unit 114 to the user and acquires various setting data input through the input unit 112. The control unit 102 stores the acquired various setting data in the storage unit 106, for example, the image data file 106a. The image processing apparatus 100 performs processing based on the setting data. The example of the setting processing has been explained hereinbefore.

Image Segmentation Processing

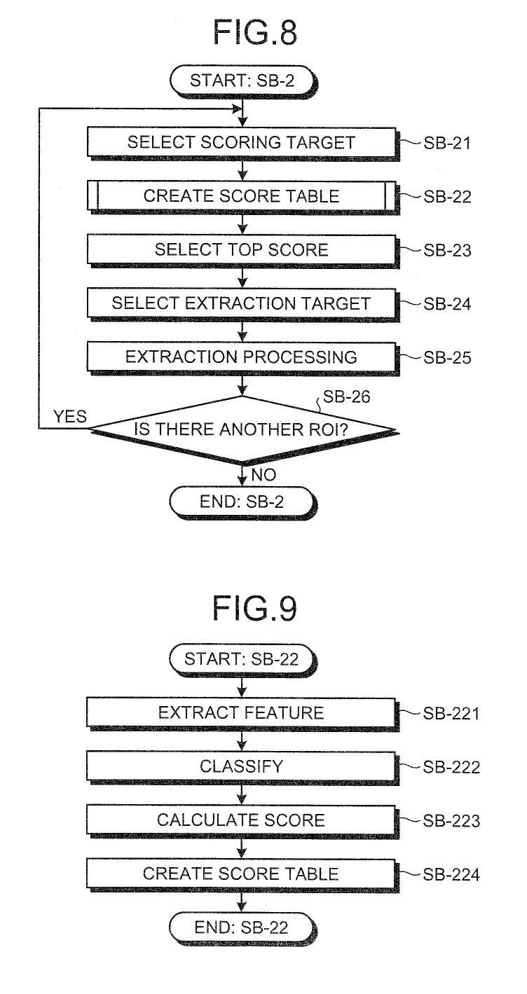

Next, image segmentation processing (step SB-2) of the overall processing explained above will be explained in detail with reference to FIG. 8. FIG. 8 is a flowchart for explaining an example of image segmentation processing according to the present embodiment.

As shown in FIG. 8, the image segmenting unit 102c selects the same image data as the image in which the ROI is indicated by the region acquiring unit 102b as a scoring target (step SB-21).

The image segmenting unit 102c generates the extraction region by using the image segmentation algorithms stored in the image segmentation algorithm library 106b with respect to the image data as the scoring target. The image segmentation algorithm selecting unit 102d compares image data of the ROI with the image data of the extraction region to calculate a score of similarity between these image data and create the score table (step SB-22). That is, the extraction regions are generated from the image data used to indicate the ROI Rg by the image segmentation algorithms A1 to A10 stored in the image segmentation algorithm library 106b, respectively, and scores of similarity between the extracted extraction regions R1 to R10 and the ROI Rg are calculated. As an example of scoring of similarity, similarity is measured by a difference between a numerical value, which is called a “feature quantity”, quantified from the indicated region Rg and that from each of the extraction regions R1 to R10.

The image segmentation algorithm selecting unit 102d selects the image segmentation algorithm in which a top score (highest similarity) is calculated based on the created score table (step SB-23). In the example explained above, the image segmentation algorithm A* that has extracted a region determined as most similar (smallest in difference) is selected as an optimum scheme.

The image segmenting unit 102c selects image data (typically, entire image data) as a segmentation target from the image data stored in the image data file 106a (step SB-24).

The image segmenting unit 102c generates the extraction region by using the image segmentation algorithm selected by the image segmentation algorithm selecting unit 102d from the entire image data as the segmentation target (step SB-25).

The image segmenting unit 102c determines whether to update the ROI (step SB-26). For example, when n images of the t(time)-axis direction are included in the image data, the image of t=0 and the image of t=n may greatly differ in circumstance. Therefore, a plurality of ROIs may be set for a plurality of images which are separated in time to increase segmentation accuracy (see the teacher mask file number input box MA-5 of FIG. 7). The image segmenting unit 102c, for example, determines whether the ROIs have been set and updates the ROI when there is image data as the segmentation target corresponding to the ROI with which an analysis is not performed yet (Yes in step SB-26). As explained above, since the ROI is updated, segmentation processing can be performed with high accuracy even in task circumstances which variously change temporarily and spatially.

When it is determined that the ROI is to be updated (Yes in step SB-26), the image segmenting unit 102c selects image data as a scoring target corresponding to the updated ROI (step SB-21) and repeats the above-explained processing for the updated ROI (step SB-22 to step SB-26).

When it is determined that a ROI that has to be updated is not present (No in step SB-26), the image segmenting unit 102c finishes processing. The image segmentation processing (step SB-2) has been explained hereinbefore.

Score Table Creating Processing

Subsequently, score table creating processing (step SB-22) of the image segmentation processing explained above will be explained in detail with reference to FIG. 9. FIG. 9 is a flowchart for explaining an example of score table creating processing according to an embodiment of the present invention.

The image segmenting unit 102c generates an extraction region from image data as a scoring target, measures a feature quantity of the extraction region, and generates a feature space from a pattern space, based on the feature extraction method stored in the image segmentation algorithm library 106b (step SB-221).

The image segmenting unit 102c makes the feature quantity on the feature space correspond to the ROI to discriminate an extraction region, based on the classification method stored in the image segmentation algorithm library 106b (step SB-222). That is, in this processing, as shown in FIG. 6, the image segmenting unit 102c restores the original image to the ROI. Therefore, the image segmenting unit 102c measures the feature quantity of the extraction region from the original image and makes (classifies) the feature quantity correspond to the ROI in the feature space representing distribution of the feature quantity to acquire image data of the extraction region.

The image segmentation algorithm selecting unit 102d compares the image data of the ROI acquired by the region acquiring unit 102b with the image data of the extraction region acquired by the image segmenting unit 102c to calculate a score of similarity between these image data (step SB-223). In further detail, the image segmentation algorithm selecting unit 102d compares feature quantities of shape and texture quantified from the image data of the extraction region and those from the image data of the ROI to calculate a score of similarity.

The feature quantities quantified by the image processing apparatus according to the embodiment of the present invention is, for example, a feature quantity derived from a intensity value and a feature quantity derived from a shape of a region. The former is focused on the intensity value that pixels in a local region have, and may include, for example, a texture feature or a directional feature. The latter may include, for example, a normal vector or a brightness gradient vector of a contour shape of a ROI, or a vector to which a complex auto-regressive coefficient is applied. Each feature quantity is stored as a one- or multi-dimensional vector.

For example, as the feature quantity derived from the intensity value that a certain pixel within a region has, a mean, a maximum, a minimum, a variance, and a standard deviation of the intensities of 25 pixels included in a 5×5 pixel region centering on the certain pixel may be used. As another example, a texture statistical quantity based on a Grey level co-occurrence matrix (GLCM) may be used. In this case, let i denote the intensity value of a certain pixel within an image region, a co-occurrence matrix M(d, θ) that has probabilities P_{δ}(i, j) (i, j=0, 1, 2, . . . n−1) that the intensity value of a pixel positioned away from the certain pixel by a constant displacement δ=(d, θ) will be j as elements is calculated. Here, d and θ denote a distance and a position angle between the two pixels. P_{δ}(i, j) has a normalized value of from 0 to 1, and the sum thereof is 1. For example, when d=1, a co-occurrence matrix of θ=0° (a horizontal direction), 45° (a right diagonal direction), 90° (a vertical direction, and 135° (a left diagonal direction) is calculated. An angular secondary moment, contrast, correlation, and entropy which characterize a texture are calculated from each matrix.

As an example of the feature quantity derived from the shape, let (xⱼ, yⱼ) (j=0, 1, . . . , N−1) denote a point sequence obtained by tracing a contour of a certain region, its complex representation is zⱼ=xⱼ+iyⱼ. For example, in the case of coordinates (x, y)=(3,0) of a certain contour pixel, a complex representation is z=3+0i. An m-order complex auto-regressive model may be represented by the following Equation.

$${\tilde{z}}_{j} = {\sum }_{k = 1}^{m} {a}_{k} {z}_{j} - k$$

This is one which is defined as a model in which a contour point is approximated by a linear combination of up to (m−1) contour points. {aₖ}ₖ₌₁^{m} denotes a coefficient of the model and is determined so that a square prediction error ε²(m)=Eⱼ|\hat{z}−zⱼ|² can be minimized.

This evaluation method represented as an example includes calculating similarity between the ROI and each extraction region by using the (normalized) feature quantity quantified as explained above. For example, when the image segmentation algorithms a₁˜a₁₀(∈A) are stored in the image segmentation algorithm library 106b, let Rg denote the ROI indicated in a part of the image data by the user, and let Rₐ₁˜Rₐ₁₀ denote the extraction regions extracted by the respective image segmentation algorithms, similarity S_{A} between the respective regions is calculated by the following equation.

S_{A}=dist(R^{g},R_{A})=dist(X^{g},X_{A})+dist(P^{g},P_{A}) (1)

Here, X=(x₁, x₂, . . . , xₘ) denotes an m-order vector feature quantity derived from a intensity value that a pixel within a region has, and P=(p₁, p₂, . . . , pₙ) denotes an n-order vector feature quantity derived from a shape of a region. A distance function dist(·) may be calculated by a Euclidean distance between vectors, but it is not limited to the Euclidean distance and may be calculated by a class distance of clusters configured by a vector distribution or a cross validation.

The image segmentation algorithm selecting unit 102d creates the score table stored by associating the feature quantity vector of the extraction region, a type of the image segmentation algorithm (that is, a combination among the feature extraction method, the classification method and the parameter), and the calculated score of similarity with each other (step SB-224).

The score table creation processing (step SB-22) according to the present embodiment has been explained hereinbefore. After creating the score table, the image segmentation algorithm selecting unit 102d performs score sorting and selects the image segmentation algorithm for which the score of highest similarity is calculated (step SB-23). Among the k image segmentation algorithms, the selected image segmentation algorithm aᵢ is defined as follows.

$${a}_{i} = arg {min}_{0 < i \leq k} {s}_{ai}$$

That is, the image segmentation algorithm in which the score of S_{A}(A=a1˜a10) calculated by Equation (1) has a minimum value (that is, highest similarity) is determined as closest to the ROI indicated by the user and optimum for image segmentation. Thereafter, as explained above, the image segmenting unit 102c performs automatic image segmentation from entire image data by using the selected image segmentation algorithm. The extraction result is stored as the mask. That is, for example, label 1 is set to a region extracted as the extraction region, and label 0 is set to the other region. How to use the mask depends on the user's intent. However, for example, in the case of desiring to display only the extraction region on the display unit 114, the second image outputting unit 102e performs the Boolean operation of the original image data and the mask to create image data in which a brightness value 0 is set to regions other than the extraction region at step SB-4 of FIG. 5.

The detail of the processing of the image processing apparatus 100 according to the present embodiment has been explained hereinbefore. As described above, the embodiment controls so that an image of the image data stored in the image data file 106a is displayed on the display unit 114, controls so that a ROI is indicated through the input unit 112 on the image displayed on the display unit 114 to acquire the image data of the ROI, generates an extraction region extracted from the image data by using each of the image segmentation algorithms stored in the image segmentation algorithm library 106b to acquire the image data of the extraction region, calculates similarity by comparing the image data of the extraction region with that of the ROI to select the image segmentation algorithm that has the highest similarity, and outputs the image data of a region extracted by using the selected image segmentation algorithm to the display unit 114. Therefore, according to the embodiment, regions corresponding to the ROI indicated by a user may be automatically extracted from a large amount of image data, and image segmentation with the high versatility can be performed for various objects.

Further, according to the embodiment, the ROI is acquired by having the user to trace a contour of a region that the user indicates on the displayed image through the pointing device as the input unit 112. Therefore, the ROI indicated by the user may be accurately acquired, and image segmentation with the high versatility may be performed according to the user's purpose.

Further, according to the embodiment, similarity is calculated between feature quantities of shape, texture and the like quantified from the image data of the extraction region and those from the image data of the ROI. Therefore, a criterion with the high versatility may be used as a criterion for measuring similarity to increase image segmentation accuracy.

Further, according to the embodiment, since the feature quantity is represented by a vector, a criterion with the higher versatility is used. Therefore, image segmentation accuracy may be increased.

Further, according to the embodiment, each component of a vector is represented by a complex number or a real number. Therefore, a criterion with higher versatility may be used to increase image segmentation accuracy.

Further, according to the embodiment, the feature quantity of shape is represented by a multi-dimension vector. Therefore, a criterion with the higher versatility may be used to increase image segmentation accuracy.

Further, according to the embodiment, the feature quantity of texture is represented by a multi-dimension vector. Therefore, a criterion with the higher versatility may be used to increase image segmentation accuracy.

Further, according to the embodiment, since image segmentation with the high versatility can be performed for various objects. For example, for image segmentation for performing quantification of an object in a microscopic image, automatic detection of a lesion, and facial recognition, the invention may be used in various fields such as a biological field (including medical care, medicine manufacture, drug discovery, biological research, and clinical inspection) or an information processing field (including a biometric authentication, a security system, and a camera shooting technique).

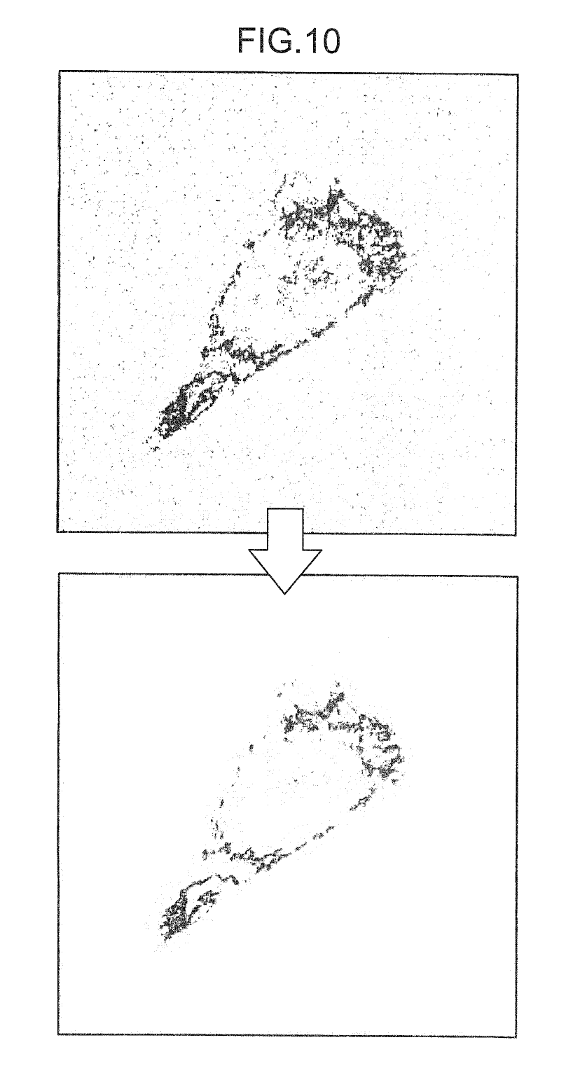

For example, when image data in which a micro-object is shot is used, since a noise is large and a size is small, various problems occur in the task for image segmentation. However, according to the embodiment, even for the image, the optimum image segmentation algorithm and parameters thereof may be automatically selected, and image segmentation with high accuracy may be performed. FIG. 10 is a view for explaining a segmentation result of a cell region according to the present embodiment.

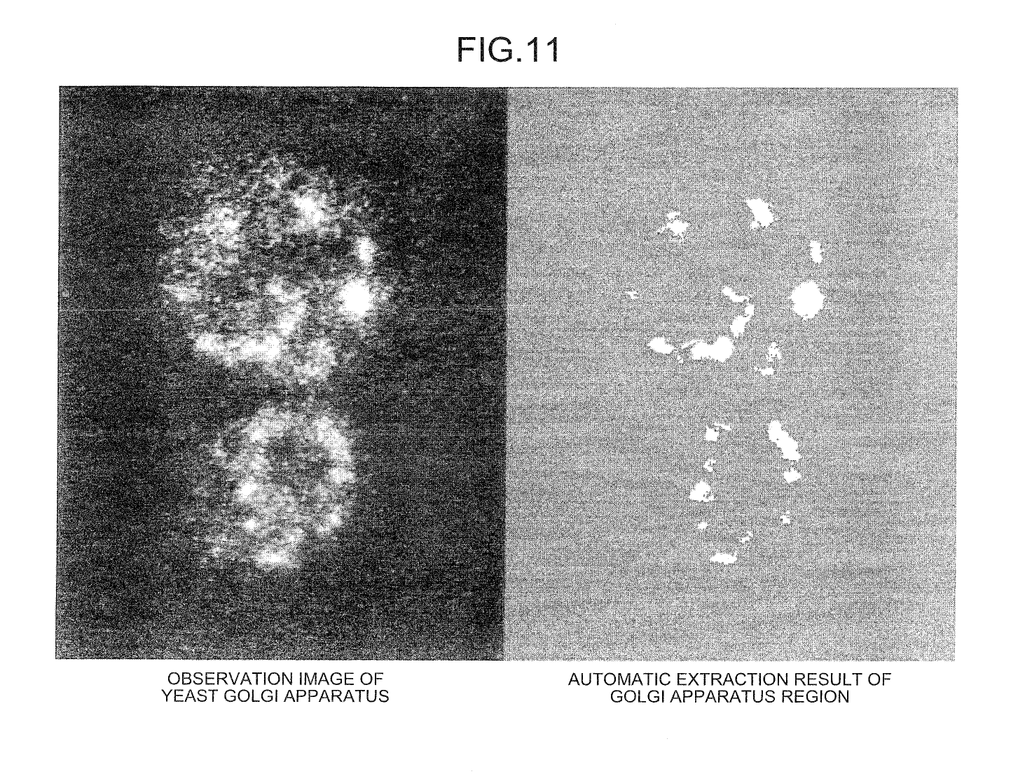

As shown in FIG. 10, according to an embodiment of the present invention, even though an image (an upper view of FIG. 10) has a lot of noises in a background and is small in size, a cell region can be accurately extracted, and an extraction region and an image can be integrated to be converted into an image with a small noise (a lower view of FIG. 10). FIG. 11 is a view for explaining an observation image (an original image) of a yeast Golgi apparatus and an image segmentation result according to the embodiment.

As shown in FIG. 11, according to an embodiment of the present invention, when the user indicates a Golgi apparatus region to set a ROI, the image segmentation algorithm optimum for the indicated ROI is selected. Therefore, even though the original image (a left view of FIG. 11) has a lot of noises, the Golgi apparatus region can be accurately automatically extracted as shown in a right view of FIG. 11. Further, according to an embodiment of the present invention, processing for a large amount of images can be performed, and a segmentation criterion is clear unlike manual works. Therefore, objective and reproducible data may be obtained. Further, quantification of as a volume or a moving speed can be performed based on an image segmentation result according to the embodiment.

Further, the embodiment may be applied to extract a facial region as pre-processing of authentication processing. Further, when an expert such as a doctor indicates a lesion region on an X-ray photograph as a ROI, the lesion region can be automatically detected from a large amount of image data. As explained above, according to embody a selecting ability of segmentation algorithm by an image processing expert, a desired segmented image can be obtained in a short time by using the embodiment. Further, the user such as a researcher can avoid wasting time and effort in reviewing an algorithm several times, and thus smooth knowledge acquisition can be expected.

### Other Embodiments

The embodiments of the present invention have been described above. However, the present invention may be executed in not only the embodiments described above but also various different embodiments within the technical idea described in the scope of the invention.

In the above embodiments, an example in which the image processing apparatus 100 mainly performs the processes in a standalone mode is explained. However, as described in the embodiments, a process may be performed in response to a request from another terminal apparatus constituted by a housing different from that of the image processing apparatus 100, and the process result may be returned to the client terminal.

Of each of the processes explained in the embodiments, all or some processes explained to be automatically performed may be manually performed. Alternatively, all or some processes explained to be manually performed may also be automatically performed by a known method.

In addition, the procedures, the control procedures, the specific names, the information including parameters such as registered data or search condition, and the database configurations which are described in the literatures or the drawings may be arbitrarily changed unless otherwise noted.

With respect to the image processing apparatus 100, the constituent elements shown in the drawings are functionally schematic. The constituent elements need not be always physically arranged as shown in the drawings.

For example, all or some processing functions of the devices in the image processing apparatus 100, in particular, processing functions performed by the control unit 102 may be realized by a central processing unit (CPU) and a program interpreted and executed by the CPU or may also be realized by hardware realized by a wired logic. The program is recorded on a recording medium (will be described later) and mechanically read by the image processing apparatus 100 as needed. More specifically, on the storage unit 106 such as a ROM or an HD, a computer program which gives an instruction to the CPU in cooperation with an operating system (OS) to perform various processes is recorded. The computer program is executed by being loaded on a RAM, and constitutes a control unit in cooperation with the CPU.

The computer program may be stored in an application program server connected to the image processing apparatus 100 through an arbitrary network 300. The computer program in whole or in part may be downloaded as needed.

A program which causes a computer to execute a method according to the present invention may also be stored in a computer readable recording medium. In this case, the “recording medium” includes an arbitrary “portable physical medium” such as a flexible disk, a magnet-optical disk, a ROM, an EPROM, an EEPROM, a CD-ROM, an MO, or a DVD or a “communication medium” such as a communication line or a carrier wave which holds a program for a short period of time when the program is transmitted through a network typified by a LAN, a WAN, and the Internet.

The “program” is a data processing method described in an arbitrary language or a describing method. As a format of the “program”, any format such as a source code or a binary code may be used. The “program” is not always singularly constructed, and includes a program obtained by distributing and arranging multiple modules or libraries or a program that achieves the function in cooperation with another program typified by an operating system (OS). In the apparatuses according to the embodiments, as a specific configuration to read a recording medium, a read procedure, an install procedure used after the reading, and the like, known configurations and procedures may be used.

Various databases or the like (image data file 106a, image segmentation algorithm library 106b and the like) stored in the storage unit 106 are a memory device such as a RAM or a ROM, a fixed disk device such as a hard disk drive, and a storage unit such as a flexible disk or an optical disk and store various programs, tables, databases, Web page files used in various processes or Web site provision.

The image processing apparatus 100 may be realized by connecting a known information processing apparatus such as a personal computer or a workstation and installing software (including a program, data, or the like) which causes the information processing apparatus to realize the method according to the present invention.

Furthermore, a specific configuration of distribution and integration of the devices is not limited to that shown in the drawings. All or some devices can be configured such that the devices are functionally or physically distributed and integrated in arbitrary units depending on various additions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus, comprising:
a storage unit; and
a control unit;
wherein the storage unit stores a plurality of image segmentation algorithms and image data, and
wherein the control unit includes:
a first image outputting unit that controls so that an image of the image data is displayed on a display unit,
a region acquiring unit that controls so that a region of interest is indicated through an input unit on the image displayed on the display unit to acquire the image data of the region of interest,
an image segmenting unit that generates an extraction region extracted from the image data by using each of the image segmentation algorithms stored in the storage unit to acquire the image data of the extraction region,
an image segmentation algorithm selecting unit that calculates similarity by comparing the image data of the extraction region with the image data of the region of interest to select the image segmentation algorithm that has the highest similarity, and
a second image outputting unit that outputs the image data of a region extracted by using the selected image segmentation algorithm to the display unit.

2. The image processing apparatus according to claim 1, wherein the input unit is a pointing device, and
wherein the region acquiring unit permits a user to trace a contour of a region that the user indicates on the image through the pointing device to acquire the region of interest.

3. The image processing apparatus according to claim 1, wherein the image segmentation algorithm selecting unit calculates similarity between feature quantities of shape and texture quantified from the image data of the extraction region and those from the image data of the region of interest.

4. The image processing apparatus according to claim 3, wherein the image segmentation algorithm selecting unit represents the feature quantity by a vector.

5. The image processing apparatus according to claim 4, wherein the image segmentation algorithm selecting unit represents each component of the vector by a complex number or a real number.

6. The image processing apparatus according to claim 4, wherein the image segmentation algorithm selecting unit represents the feature quantity of the shape by a multi-dimensional vector.

7. The image processing apparatus according to claim 4, wherein the image segmentation algorithm selecting unit represents the feature quantity of the texture by a multi-dimensional vector.

8. An image processing method executed by an information processing apparatus including a storage unit, and a control unit, wherein the storage unit stores a plurality of image segmentation algorithms and image data, the method comprising:
(i) a first image outputting process of controlling so that an image of the image data is displayed on a display unit;
(ii) a region acquiring process of controlling so that a region of interest is indicated through an input unit on the image displayed on the display unit to acquire the image data of the region of interest;
(iii) an image segmenting process of generating an extraction region extracted from the image data by using each of the image segmentation algorithms stored in the storage unit to acquire the image data of the extraction region;
(iv) an image segmentation algorithm selecting process of calculating similarity by comparing the image data of the extraction region with the image data of the region of interest to select the image segmentation algorithm that has the highest similarity; and
(v) a second image outputting process of outputting the image data of a region extracted by using the selected image segmentation algorithm to the display unit,
wherein the processes (i) to (v) are executed by the control unit.

9. The image processing method according to claim 8, wherein the input unit is a pointing device, and
wherein at the region acquiring process, the control unit permits a user to trace a contour of a region that the user indicates on the image through the pointing device to acquire the region of interest.

10. The image processing method according to claim 8, wherein at the image segmentation algorithm selecting process, the similarity is calculated between feature quantities of shape and texture quantified from the image data of the extraction region and those from the image data of the region of interest.

11. A computer program product having a computer readable medium including programmed instructions for a computer including a storage unit, and a control unit, wherein the storage unit stores a plurality of image segmentation algorithms and image data, and wherein the instructions, when executed by the computer, cause the computer to perform:
(i) a first image outputting process of controlling so that an image of the image data is displayed on a display unit;
(ii) a region acquiring process of controlling so that a region of interest is indicates through an input unit on the image displayed on the display unit to acquire the image data of the region of interest;
(iii) an image segmenting process of generating an extraction region extracted from the image data by using each of the image segmentation algorithms stored in the storage unit to acquire the image data of the extraction region;
(iv) an image segmentation algorithm selecting process of calculating similarity by comparing the image data of the extraction region with the image data of the region of interest to select the image segmentation algorithm that has the highest similarity; and
(v) a second image outputting process of outputting the image data of a region extracted by using the selected image segmentation algorithm to the display unit, and
wherein the processes (i) to (v) are executed by the control unit.

12. The computer program product according to claim 11,
wherein the input unit is a pointing device, and wherein at the region acquiring process, the control unit permits a user to trace a contour of a region that the user indicates on the image through the pointing device to acquire the region of interest.

13. The computer program product according to claim 11, wherein at the image segmentation algorithm selecting process, the similarity is calculated between feature quantities of shape and texture quantified from the image data of the extraction region and those from the image data of the region of interest.
